(19) United States
(12) Patent Application Publication
(10) Pub. No.: US 2023/0372932 A1
(43) Pub. Date: Nov. 23, 2023

(54) PRESS-BASED FLUIDIC TRANSPORTATION AND DIAGNOSIS DEVICE AND DETECTION METHOD OF SOLUTION COLORIMETRIC ANALYSIS

(71) Applicant: NATIONAL TSING HUA UNIVERSITY, HSINCHU (TW)

(72) Inventors: Yen-Ching TAI, Hsinchu (TW); Jen-Huang HUANG, Hsinchu (TW); Yu-Jyun CHENG, Taipei City (TW); Xin Han CHEONG, Hsinchu (TW)

(21) Appl. No.: 17/811,307

(22) Filed: Jul. 8, 2022

(30) Foreign Application Priority Data
May 23, 2022 (TW) 111119153

(51) Int. Cl. B01L 3/00

(52) U.S. Cl. CPC B01L 3/50273; B01L 2300/087; B01L 2200/16; B01L 2300/0816; B01L 2400/0487

(57) ABSTRACT

A press-based fluidic transportation and diagnosis device includes a top plate, a first reagent storage chamber, a second reagent storage chamber, a sample inflow chamber, a detection chamber, a through hole and a gas outlet hole. On end of the second reagent storage chamber is communicated with the first reagent storage chamber by a first flow path. The sample inflow chamber is communicated with the other end of the second reagent storage chamber by a second flow path. On end of the detection chamber is communicated with the sample inflow chamber by a third flow path. The through hole is used for accommodating a press-based driving unit, and is communicated with the other end of the detection chamber by a fourth flow path. The gas outlet hole is communicated with the through hole by a fifth flow path.

### RELATED APPLICATIONS

This application claims priority to Taiwan Application Serial Number 111119153, filed May 23, 2022, which is herein incorporated by reference.

### BACKGROUND

### Technical Field

The present disclosure relates to a microfluidic device and a detection method. More particularly, the present disclosure relates to a press-based fluidic transportation and diagnosis device and a detection method of solution colorimetric analysis.

### Description of Related Art

Nowadays, numerous diseases can be prevented by early diagnosis, and the cause of diseases, the effectiveness of treatment, monitoring the health and the screening of potential illness can be understood by the diagnosis. The diagnosis is usually operated by sophisticated-trained clinical staff in hospitals or laboratories. However, in remote areas or developing countries, the limited access to medical resources like medical instruments or well-trained medical personnel, and the cost of diagnosis or medical treatment is another reason that may lead to a low willingness to seek medical attention.

Along with the changing of the need for the healthcare, the lost-cost patient-centralized clinical treatments have gradually arisen. The demands for real-time and accurate disease detection or classification are especially urgent due to the large and rapid growth population increases the requirement in the medical treatments. The concept of point of care treatment (POCT) has been developed following the tendency. POCT is defined as the testing at or near the site of patient care whenever the medical care is needed offers lots of advantages compared with the conventional clinical treatments. For instance, minimize the sample volume, widen the diagnosis accessibility, and reduce the time and cost, etc. The requirements for POCT devices are simple to be used, the storage and usage of reagents and consumables are strong, and the results are complying with the clinical standard request.

One of the characteristics of POCT is to obtain the reliable result in the short time, thus, the rapid diagnosis of the device is important. To reach the purpose, a microfluidic device is a potential candidate in developing systems for real-time detection. The microfluidic device is a kind of technology of manipulating fluids on a small scale with the channel scale in tens to hundreds of micrometers. It offers the ability to process samples or reagents in less volume than the usual scale, and can be used in some specific tests with real-time and accurate results by optimizing the device and experiments. Thus, the application of the microfluidic device in the clinical diagnosis is the significant research, and can be able to replace some clinical detection or provide better medical services to the patients.

Therefore, how to design a device that is easy to carry and can be tested anytime and anywhere, so as to establish a real-time, easy to operate and high accuracy detection system to achieve the needs of POCT, has become the goal of the relevant scholars and industry.

### SUMMARY

According to one aspect of the present disclosure, a press-based fluidic transportation and diagnosis device is provided. The press-based fluidic transportation and diagnosis device includes a top plate, a first reagent storage chamber, a second reagent storage chamber, a sample inflow chamber, a detection chamber, a through hole and a gas outlet hole. The top plate includes a first reagent inflow hole, a second reagent inflow hole and a sample inflow hole. The first reagent storage chamber is for storing a first reagent, and the first reagent inflow hole is correspondingly disposed above the first reagent storage chamber. The second reagent storage chamber is for storing a second reagent, one end of the second reagent storage chamber is communicated with the first reagent storage chamber by a first flow path, and the second reagent inflow hole is correspondingly disposed above the second reagent storage chamber. The sample inflow chamber includes a separation membrane, the sample inflow chamber is communicated with the other end of the second reagent storage chamber by a second flow path, and the sample inflow hole is correspondingly disposed above the sample inflow chamber. One end of the detection chamber is communicated with the sample inflow chamber by a third flow path. The through hole is for accommodating a press-based driving unit, and the through hole is communicated with the other end of the detection chamber by a fourth flow path. The gas outlet hole is communicated with the through hole by a fifth flow path.

According to another aspect of the present disclosure, a detection method of solution colorimetric analysis includes steps as follows. The press-based fluidic transportation and diagnosis device according to the aforementioned aspect is provided. A reagent filling step is performed, wherein the first reagent is filled into the first reagent storage chamber from the first reagent inflow hole, the second reagent is filled into the second reagent storage chamber from the second reagent inflow hole, and a detachable sealing film is used to seal the first reagent inflow hole and a tape is used to seal the second reagent inflow hole. A sample inflowing step is performed, wherein a sample is injected into the sample inflow hole, and the press-based driving unit is pressed simultaneously, so that an air in the press-based fluidic transportation and diagnosis device is discharged from the gas outlet hole. A sample separating step is performed, wherein the gas outlet hole is blocked and the press-based driving unit is released, so that the sample is separated and purified by the separation membrane to obtain a tested substance. A degassing step is performed, wherein the detachable sealing film is torn off and sealing the sample inflow hole, and the press-based driving unit is pressed repeatedly, so that the air in the press-based fluidic transportation and diagnosis device is discharged from the gas outlet hole. A mixing step is performed, wherein the gas outlet hole is blocked and the press-based driving unit is released, so that the first reagent and the second reagent are flowed into the sample inflow chamber and reacted with the tested substance to form a detected solution, and the detected solution is flowed into the detection chamber by the third flow path. A detecting step is performed, wherein a result of the detected solution is analyzed by a colorimetry.

### BRIEF DESCRIPTION OF THE DRAWINGS

The patent or application file contains at least one drawing executed in color. Copies of this patent or patent application publication with color drawing(s) will be provided by Office upon request and payment of the necessary fee. The present disclosure can be more fully understood by reading the following detailed description of the embodiment, with reference made to the accompanying drawings as follows:

FIG. 1 is a schematic diagram of a press-based fluidic transportation and diagnosis device according to one embodiment of the present disclosure.

FIG. 2 is a top perspective view of the press-based fluidic transportation and diagnosis device as shown in FIG. 1.

FIG. 3 is a cross-sectional view of the press-based fluidic transportation and diagnosis device along line 3-3 as shown in FIG. 1.

FIG. 4 is a cross-sectional view of the press-based fluidic transportation and diagnosis device along line 4-4 as shown in FIG. 1.

FIG. 5 is an exploded view of the press-based fluidic transportation and diagnosis device as shown in FIG. 1.

FIG. 6 is a flow chart of a detection method of solution colorimetric analysis according to another embodiment of the present disclosure.

FIG. 7A, FIG. 7B, FIG. 7C, FIG. 7D, FIG. 7E, FIG. 7F and FIG. 7G are schematic process diagrams of the detection method of solution colorimetric analysis as shown in FIG. 6.

FIG. 8 is a schematic diagram of a self-made gray value color code chart and a reaction window.

FIG. 9 is a calibration curve of a mean gray value and a concentration of a bilirubin standard solution after the reaction.

### DETAILED DESCRIPTION

The present disclosure will be further exemplified by the following specific embodiments along drawings thereof so as to facilitate utilizing and practicing the present disclosure completely by the people skilled in the art without over-interpreting and over-experimenting. However, the readers should understand that the present disclosure should not be limited to these practical details thereof, that is, in some embodiments, these practical details are used to describe how to implement the materials and methods of the present disclosure and are not necessary. Furthermore, in order to simplify the drawings, some conventional structures and elements will be illustrated in a simple manner in the drawings, and the repeated elements may be represented by the same reference numerals.

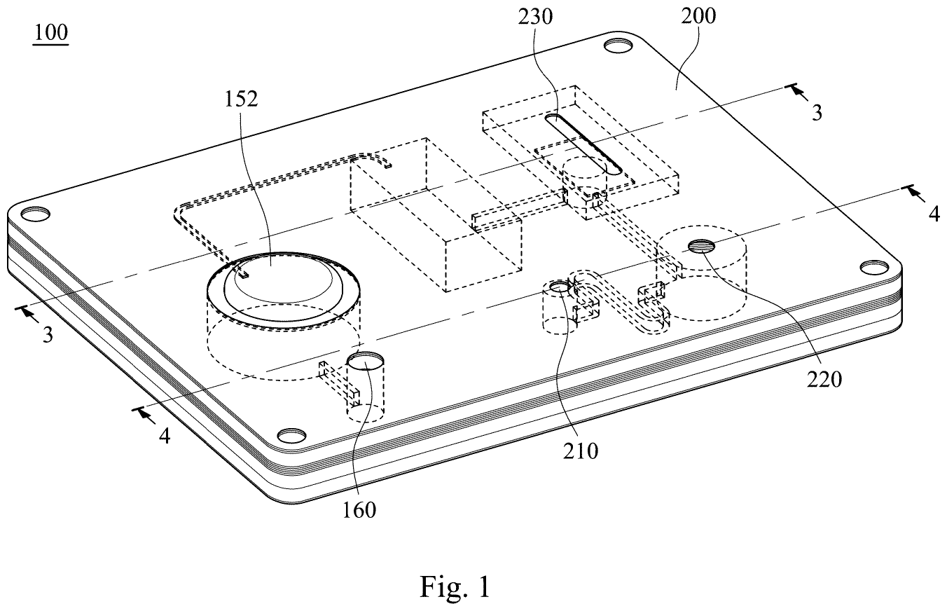

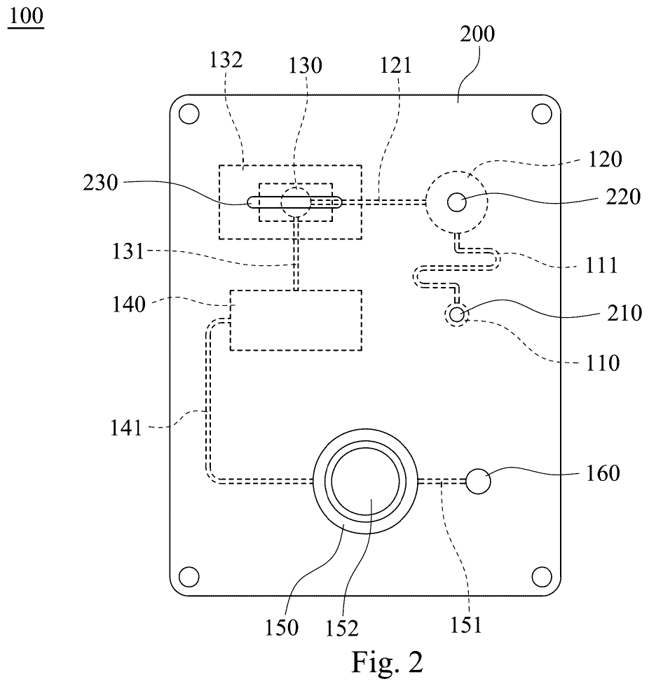

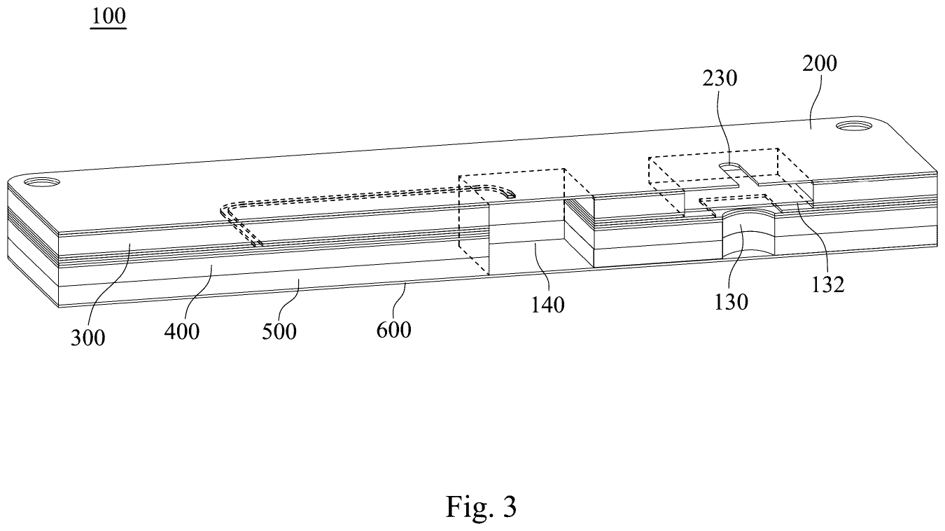

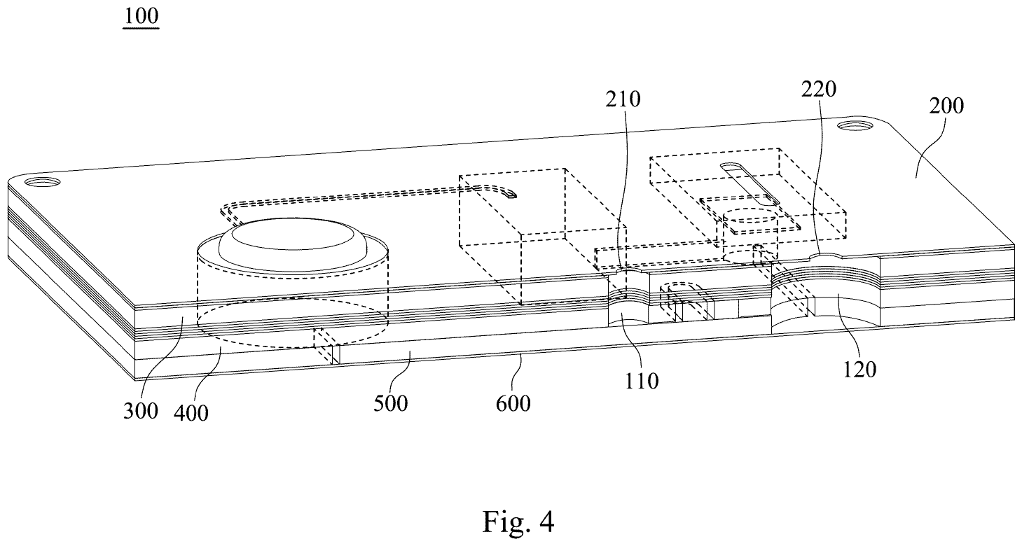

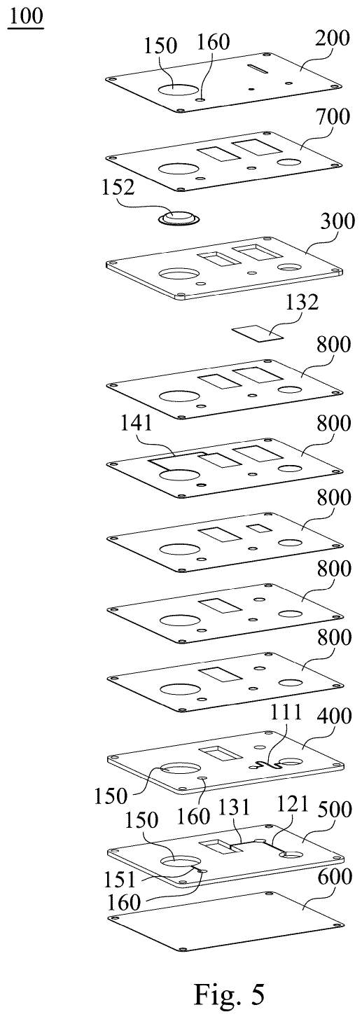

Please refer to FIG. 1, FIG. 2, FIG. 3, FIG. 4 and FIG. 5, wherein FIG. 1 is a schematic diagram of a press-based fluidic transportation and diagnosis device 100 according to one embodiment of the present disclosure. FIG. 2 is a top perspective view of the press-based fluidic transportation and diagnosis device 100 as shown in FIG. 1. FIG. 3 is a cross-sectional view of the press-based fluidic transportation and diagnosis device 100 along line 3-3 as shown in FIG. 1. FIG. 4 is a cross-sectional view of the press-based fluidic transportation and diagnosis device 100 along line 4-4 as shown in FIG. 1. FIG. 5 is an exploded view of the press-based fluidic transportation and diagnosis device 100 as shown in FIG. 1. As shown in FIG. 1 to FIG. 5, the press-based fluidic transportation and diagnosis device 100 includes a top plate 200, a first reagent storage chamber 110, a second reagent storage chamber 120, a sample inflow chamber 130, a detection chamber 140, a through hole 150 and a gas outlet hole 160.

Specifically, the top plate 200 includes a first reagent inflow hole 210, a second reagent inflow hole 220 and a sample inflow hole 230. The first reagent storage chamber 110 is for storing a first reagent, and the first reagent inflow hole 210 is correspondingly disposed above the first reagent storage chamber 110. The second reagent storage chamber 120 is for storing a second reagent, and one end of the second reagent storage chamber 120 is communicated with the first reagent storage chamber 110 by a first flow path 111. The second reagent inflow hole 220 is correspondingly disposed above the second reagent storage chamber 120. The sample inflow chamber 130 includes a separation membrane 132, and the sample inflow chamber 130 is communicated with the other end of the second reagent storage chamber 120 by a second flow path 121. The sample inflow hole 230 is correspondingly disposed above the sample inflow chamber 130. One end of the detection chamber 140 is communicated with the sample inflow chamber 130 by a third flow path 131. The through hole 150 is for accommodating a press-based driving unit 152, and the through hole 150 is communicated with the other end of the detection chamber 140 by a fourth flow path 141. The gas outlet hole 160 is communicated with the through hole 150 by a fifth flow path 151. In detail, a volume of the first reagent storage chamber 110 is smaller than a volume of the second reagent storage chamber 120, which depends on a volume of the first reagent and a volume of the second reagent in a single test. A material of the press-based driving unit 152 can be nitrile butadiene rubber (NBR), which has better mechanical strength than latex, and can overcome the atmospheric pressure inside the device.

Therefore, the press-based fluidic transportation and diagnosis device 100 of the present disclosure utilizes the design of the press-based driving unit 152 can drive the liquid flow without any external power. Furthermore, the test reagent is built in the device can react with the sample directly by the principle of the micro-channel mixing technology to achieve the purpose of rapid screening. Moreover, as long as the press-based driving unit 152 is pressed to the end by the finger, it is enough to let the liquid flow, and due to the press strength does not need to be too large and the error-proof design is added, it can ensure consistent repeatability with every time pressing.

As shown in FIG. 3, FIG. 4 and FIG. 5, the press-based fluidic transportation and diagnosis device 100 sequentially includes a first substrate 300, a second substrate 400, a third substrate 500 and a bottom plate 600 from the top plate 200. Specifically, the top plate 200, the first substrate 300, the second substrate 400, the third substrate 500 and the bottom plate 600 are sequentially stacked so as to form the first reagent storage chamber 110, the second reagent storage chamber 120, the sample inflow chamber 130 and the detection chamber 140. The top plate 200, the first substrate 300, the second substrate 400 and the third substrate 500 are sequentially stacked so as to form the through hole 150 and the gas outlet hole 160.

Further, as shown in FIG. 5, the press-based fluidic transportation and diagnosis device 100 further includes a first plastic sheet 700 and a plurality of second plastic sheets 800, wherein the first plastic sheet 700 is disposed between the top plate 200 and the first substrate 300, and the second plastic sheets 800 are disposed between the first substrate 300 and the second substrate 400. Thus, not only the installation margin of the top plate 200, the first substrate 300, the second substrate 400, the third substrate 500 and the bottom plate 600 of the press-based fluidic transportation and diagnosis device 100 can be improved effectively, but also the structure of the press-based fluidic transportation and diagnosis device 100 can be more stable, so as to improve the stability of the fluid flow rate.

Moreover, the top plate 200, the first substrate 300, the second substrate 400, the third substrate 500, the bottom plate 600, the first plastic sheet 700 and the second plastic sheets 800 can be made by CO₂ laser cutting method. Therefore, it is favorable for cutting quickly and accurately. The material of the top plate 200, the first substrate 300, the second substrate 400, the third substrate 500, the bottom plate 600, the first plastic sheet 700 and the second plastic sheets 800 can be made of different resin polymer materials according to actual needs, so that the manufacturing efficiency thereof can be enhanced and it is favorable for mass production. In detail, the top plate 200, the bottom plate 600, the first plastic sheet 700 and the second plastic sheets 800 are made of polyethylene terephthalate (PET), which can prevent liquid leakage, be easy laminate manufacturing, and have the light transmittance. Furthermore, the first substrate 300, the second substrate 400 and the third substrate 500 are made of polymethacrylate (PMMA), which has rigidity, chemical resistance and light transmittance, and enables reagents and samples to be operated, stored and reacted. The thickness of the first substrate 300, the second substrate 400 and the third substrate 500 may preferable be 1.5 mm, respectively. Therefore, the press-based fluidic transportation and diagnosis device 100 of the present disclosure is made of plastic material, and has no other electronic or sensing elements, so that the manufacturing cost is relatively low. Furthermore, after using the device, it can be directly destroyed as the medical waste.

As shown in FIG. 5, the first flow path 111 is disposed on the second substrate 400. Preferably, the first flow path 111 can be a curved type and has a width of 0.4 mm, and the first flow path 111 is used to separate the first reagent and the second reagent to prevent the reagents from reacting with each other and lose the ability to react with the sample. The second flow path 121, the third flow path 131 and the fifth flow path 151 are disposed on the third substrate 500, and the fourth flow path 141 is disposed on one of the second plastic sheets 800.

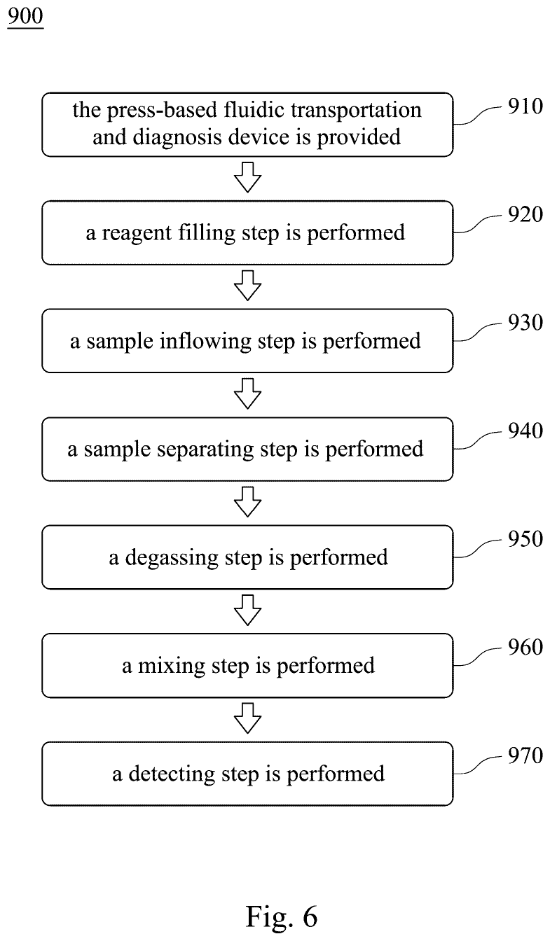

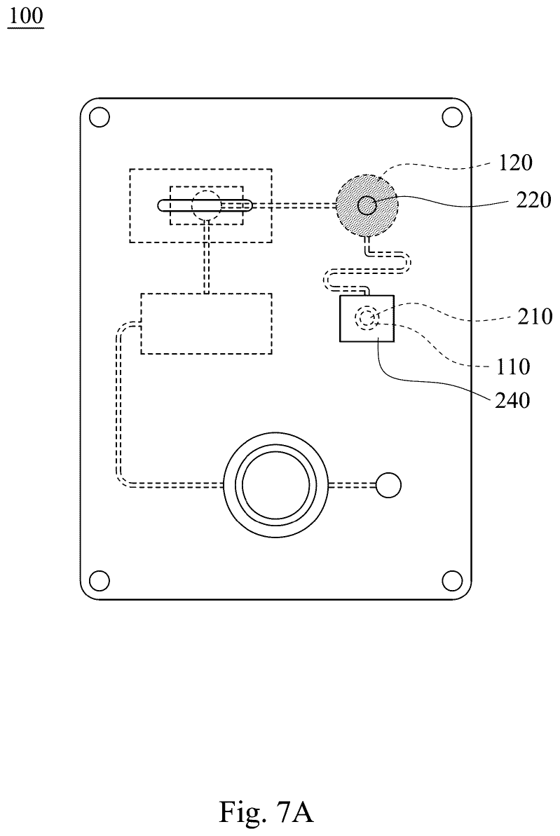

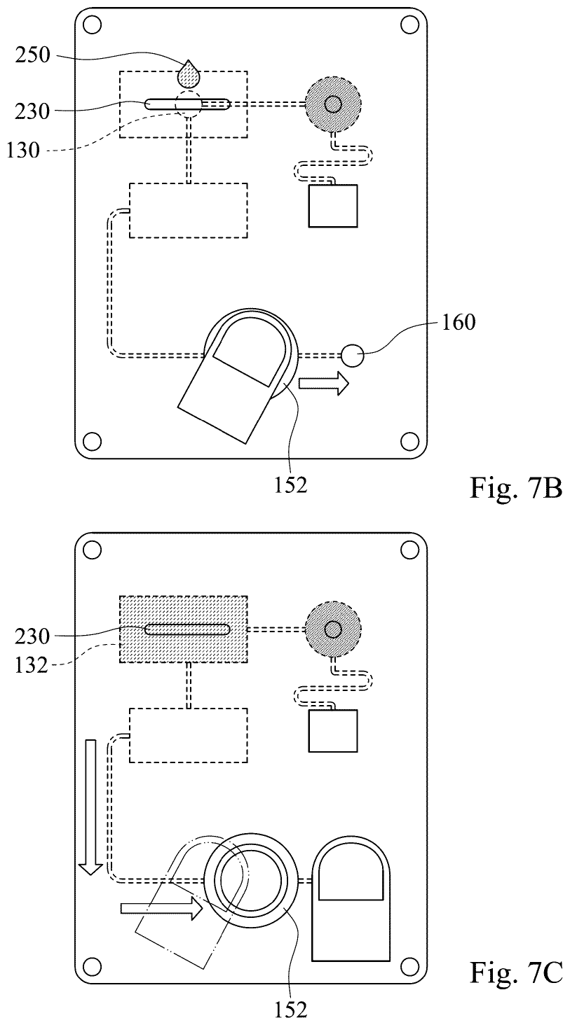

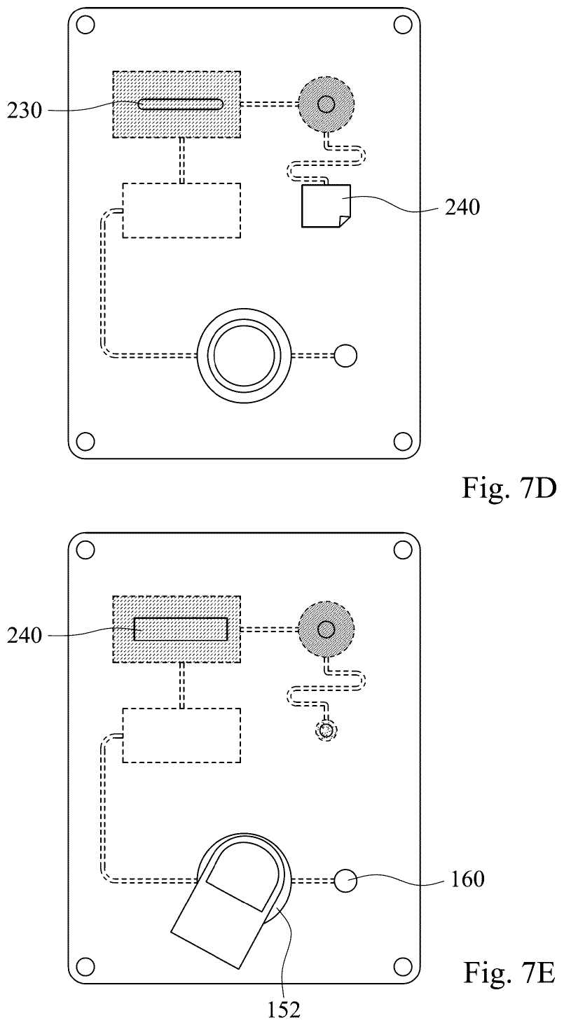

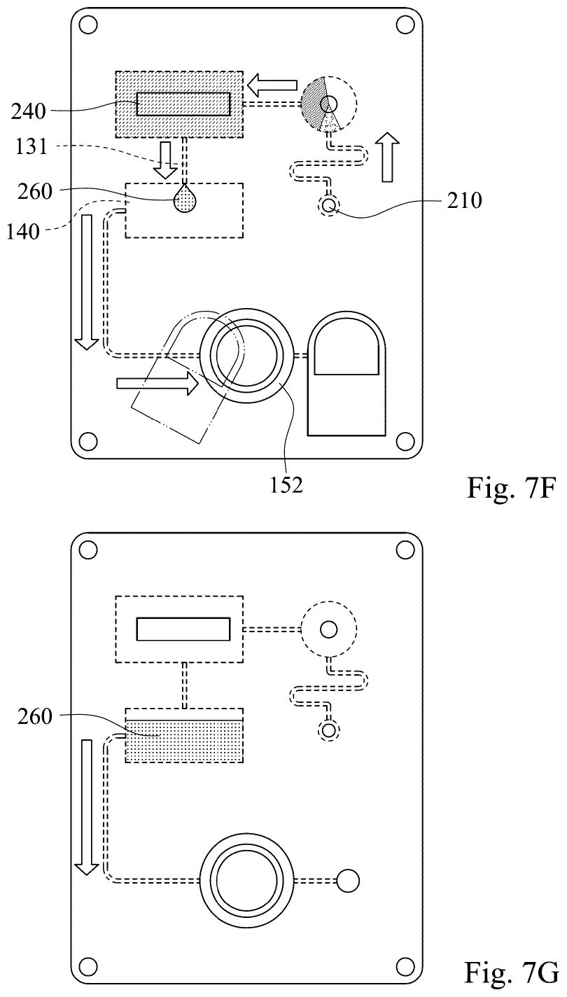

Please refer to FIG. 6, which is a flow chart of a detection method of solution colorimetric analysis 900 according to another embodiment of the present disclosure. In FIG. 6, the detection method of solution colorimetric analysis 900 includes a step 910, a step 920, a step 930, a step 940, a step 950, a step 960 and a step 970. At the same time, please refer to FIG. 7A, FIG. 7B, FIG. 7C, FIG. 7D, FIG. 7E, FIG. 7F and FIG. 7G. FIG. 7A, FIG. 7B, FIG. 7C, FIG. 7D, FIG. 7E, FIG. 7F and FIG. 7G are schematic process diagrams of the detection method of solution colorimetric analysis 900 as shown in FIG. 6.

In the step 910, the press-based fluidic transportation and diagnosis device is provided. Preferably, in the embodiment of FIG. 6, the aforementioned press-based fluidic transportation and diagnosis device can be the press-based fluidic transportation and diagnosis device 100 of FIG. 1, so as to be used for subsequent detection.

In the step 920, a reagent filling step is performed. As shown in FIG. 7A, wherein the first reagent is filled into the first reagent storage chamber 110 from the first reagent inflow hole 210, the second reagent is filled into the second reagent storage chamber 120 from the second reagent inflow hole 220, and a detachable sealing film 240 is used to seal the first reagent inflow hole 210 and a tape (not shown) is used to seal the second reagent inflow hole 220.

In the step 930, a sample inflowing step is performed. As shown in FIG. 7B, wherein a sample 250 is injected into the sample inflow hole 230, and the press-based driving unit 152 is pressed simultaneously, so that an air in the press-based fluidic transportation and diagnosis device 100 is discharged from the gas outlet hole 160. A volume of the sample 250 can be 20 μL to 100 μL.

In the step 940, a sample separating step is performed. As shown in FIG. 7C, wherein the gas outlet hole 160 is blocked and the press-based driving unit 152 is released, so that the sample 250 is separated and purified by the separation membrane 132 to obtain a tested substance (not shown). Specifically, due to the air in the press-based fluidic transportation and diagnosis device 100 is discharged, and the gas outlet hole 160 is blocked, the press-based driving unit 152 is released, the press-based fluidic transportation and diagnosis device 100 will be in the pseudo-vacuum condition. At this time, the sample inflow hole 230 is the only connection with the external atmospheric pressure. In order to achieve the pressure balance, the sample 250 is carried into the press-based fluidic transportation and diagnosis device 100, and separated and purified by the separation membrane 132. The purified tested substance will remain in the sample inflow chamber 130, wherein an area of the separation membrane 132 can be 1 cm² to 3 cm².

In the step 950, a degassing step is performed. As shown in FIG. 7D and FIG. 7E, wherein the detachable sealing film 240 is torn off and sealing the sample inflow hole 230, and the press-based driving unit 152 is pressed repeatedly, so that the air in the press-based fluidic transportation and diagnosis device 100 is discharged from the gas outlet hole 160.

In the step 960, a mixing step is performed. As shown in FIG. 7F and FIG. 7G, wherein the gas outlet hole 160 is blocked and the press-based driving unit 152 is released, so that the first reagent and the second reagent are flowed into the sample inflow chamber 130 and reacted with the tested substance to form a detected solution 260, and the detected solution 260 is flowed into the detection chamber 140 by the third flow path 131. Specifically, the press-based fluidic transportation and diagnosis device 100 presents the pseudo-vacuum condition again. However, because the detachable sealing film 240 on the first reagent inflow hole 210 is torn off and sealing the sample inflow hole 230. At this time, the first reagent inflow hole 210 is the only connection with the external atmospheric pressure. In order to achieve the pressure balance, the first reagent and the second reagent are flowed into the sample inflow chamber 130, and reacted with the tested substance to form the detected solution 260, and then the detected solution 260 is flowed into the detection chamber 140. The first reagent and the second reagent need to be mixed with each other to react with the tested substance.

In the step 970, a detecting step is performed, wherein a result of the detected solution 260 is analyzed by a colorimetry.

The present disclosure will be further exemplified by the following specific embodiments so as to facilitate utilizing and practicing the present disclosure completely by the people skilled in the art without over-interpreting and over-experimenting. However, the readers should understand that the present disclosure should not be limited to these practical details thereof, that is, these practical details are used to describe how to implement the materials and methods of the present disclosure and are not necessary.

### Example

The press-based fluidic transportation and diagnosis device of the present disclosure can be used to detect the bilirubin concentration, the drug resistance detection of virus in urine, the environmental poison detection or other detection requirements. The following will take the detection of the bilirubin concentration in newborn as an example. Specifically, the present disclosure uses the diazo method to detect the concentration of bilirubin, which uses pink bilirubin to react with a diazo reagent to form fuchsia azobilirubin, and the concentration value of bilirubin can be obtained by directly comparing the concentration with the known bilirubin standard solution by the colorimetry.

### Preparation of Bilirubin Sample and Reagent

First, the sample of the present disclosure is whole blood, the tested substance is plasma, and the detected solution is an azobilirubin solution, and the separation membrane is the plasma separation membrane, which is used to separate the blood cell and the plasma. However, when the plasma separation membrane is applied to undiluted whole blood, there has the limitation between the content of the whole blood and the area of the separation membrane. When the content of the whole blood is too large, the area of the plasma separation membrane will increase, which is unfavorable for the advantage of the device of the present disclosure with small volume. Thus, the whole blood can be diluted, or when the whole blood without the dilution, the content of the whole blood can be 50 μL to perform the subsequent detection.

In the Example of the present disclosure, 20 μL of the whole blood is added to an eppendorf tube filled with 80 μL of EDTA buffer for diluting to obtain 100 μL of the sample. The effect of EDTA buffer is to prevent coagulation and increase the volume of the sample, and the area of the separation membrane can be 2 cm². Furthermore, sodium benzoate, caffeine and sodium acetate are mixed as the first reagent, and sulfanilic acid, hydrochloric acid and sodium nitrite are mixed as the second reagent, and the ratio of the content of plasma to the total content of the first reagent and the second reagent is 1:35, preferably, the content of the first reagent is 25 μL, and the content of the second reagent is 255 μL.

### Preparation of Bilirubin Standard Solution

The concentration of bilirubin standard solution needs to consider the serum bilirubin level in the newborn, and in order to reach the purpose of preventing severe jaundice, preferably, the concentration of bilirubin standard solution can be 0 to 25 mg/dL. Specifically, 2.5 mg of the bilirubin powder is put into the 1.5 mL eppendorf tube, and dissolved in 667 μL of NaHCO₃ aqueous solution (0.1 mol/L) and 333 μL of dimethyl sulfoxide (DMSO) to obtain 25 mg/dL of bilirubin standard solution. The NaHCO₃ aqueous solution and DMSO are treated with the degassing procedure by ultrasonic in the ice bath to prevent the volatilization of liquid. The degassing procedure is to reduce the affection of air to the bilirubin resolution or stability. The other concentrations of bilirubin standard solutions are prepared by diluting the 25 mg/dL bilirubin standard solution with the blank solution, and the blank solution is composed of DMSO and NaHCO₃ aqueous solution in the ratio 1:2.

### Detection Method of Bilirubin

Please refer to the press-based fluidic transportation and diagnosis device 100 of FIG. 1 and the step 910 to the step 970 in the detection method of solution colorimetric analysis 900 of FIG. 6. First, the first reagent is filled into the first reagent storage chamber 110, the second reagent is filled into the second reagent storage chamber 120, and the detachable sealing film 240 is used to seal the first reagent inflow hole 210 and the tape (not shown) is used to seal the second reagent inflow hole 220. Further, 100 μL of the diluted blood sample is injected into the sample inflow hole 230, the press-based driving unit 152 is pressed simultaneously to discharge the air, and then the gas outlet hole is blocked. Next, the press-based driving unit 152 is released. Due to the negative pressure in the device, the blood sample is flowed into the device. The purpose of separating plasma and blood cell and purifying is achieved by the plasma separation membrane, and only plasma can be flowed into the sample inflow chamber 130 by the plasma separation membrane.

After that, the detachable sealing film 240 on the first reagent inflow hole 210 is torn off and covering the sample inflow hole 230, and the press-based driving unit 152 is pressed repeatedly to discharge the air and the gas outlet hole is blocked. Then, the press-based driving unit 152 is released to generate the negative pressure state in the device, so that the first reagent and the second reagent are flowed into the sample inflow chamber 130 and reacted with the plasma to form the azobilirubin solution. Finally, the azobilirubin solution is flowed into the detection chamber 140 and to preliminarily judge the reaction result by colorimetry.

### Result Analysis of Bilirubin Concentration Value

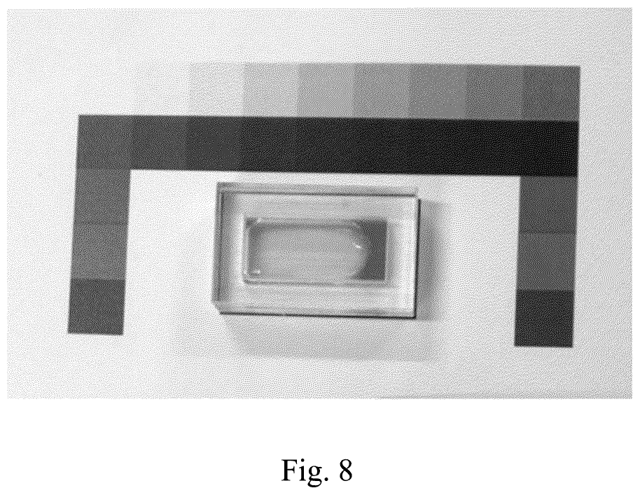

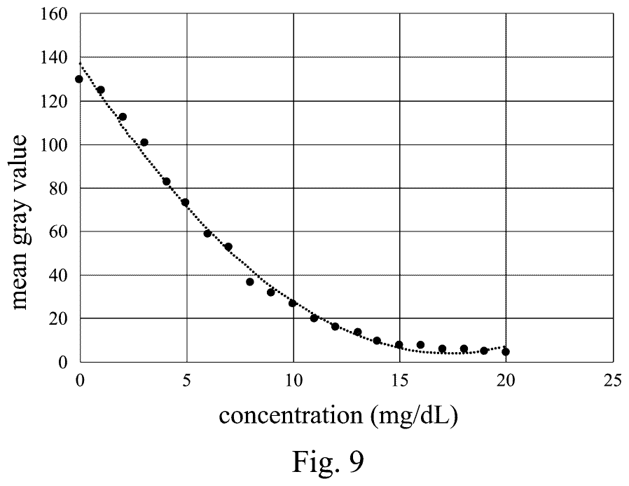

Please refer to FIG. 8 and FIG. 9, wherein FIG. 8 is a schematic diagram of a self-made gray value color code chart and a reaction window. FIG. 9 is a calibration curve of a mean gray value and a concentration of a bilirubin standard solution after the reaction.

First, the prepared bilirubin standard solutions of the different concentrations are reacted with the total bilirubin reagent in the eppendorf tube, and finding out the correlation between the color and the bilirubin concentration. In order to transform the color of the reacted solution into a digital value, the gray value of each color is analyzed. Specifically, as shown in FIG. 8, the reacted solution is put into the reaction window, and a digital camera is used to take photos of the self-made gray value color code chart and the reaction window under the same condition. Then, the colored photo is transformed into an 8-bit type picture, and the pictures are analyzed by ImageJ to obtain the gray values of each concentration of the reacted bilirubin standard solutions. Finally, a calibration curve is established to fit the gray values and the concentration of the bilirubin standard solutions. The results are shown in FIG. 9, and it can be seen that the correlation between the concentration and the gray value of the bilirubin standard solution is not a linear relationship. Therefore, in the present disclosure, the colorimetry can be used to preliminarily judge the concentration of the azobilirubin solution in the detection chamber 140, and the calibration curve of the mean gray value and the concentration obtained from the known bilirubin standard solution can be matched. Furthermore, the analysis is performed directly by the smartphone with camera function, and the mobile application designed for colorimetry is developed, so that the accurate bilirubin concentration value can be immediately obtained anytime and anywhere.

Therefore, the press-based fluidic transportation and diagnosis device 100 of the present disclosure can be achieve the detection of bilirubin concentration with a drop of blood that can be completed, and has the advantages, such as low requirements for sample and reagent, good cost-effectiveness, and good portability, and it can make the test results meet the standard of clinical implementation in the short period of time, so that the medical staff can preliminarily determine the diseases that the newborn may suffer from and the care measures that need to be taken to reduce the unnecessary case sampling and medical resource waste.

In conclusion, the press-based fluidic transportation and diagnosis device of the present disclosure combines the technology of microfluidic, and develops a kind of fast screening device without external power, which can shorten the detection time, and the volume of the device is small, easy to carry and can be tested anytime and anywhere. It can provide rapid testing for areas with lack of medical resource and no large-scale testing equipment to meet the need of point of care treatment.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A press-based fluidic transportation and diagnosis device, comprising:
a top plate comprising a first reagent inflow hole, a second reagent inflow hole and a sample inflow hole;
a first reagent storage chamber for storing a first reagent, and the first reagent inflow hole correspondingly disposed above the first reagent storage chamber;
a second reagent storage chamber for storing a second reagent, one end of the second reagent storage chamber communicated with the first reagent storage chamber by a first flow path, and the second reagent inflow hole correspondingly disposed above the second reagent storage chamber;
a sample inflow chamber comprising a separation membrane, the sample inflow chamber communicated with the other end of the second reagent storage chamber by a second flow path, and the sample inflow hole correspondingly disposed above the sample inflow chamber;
a detection chamber, wherein one end of the detection chamber is communicated with the sample inflow chamber by a third flow path;
a through hole for accommodating a press-based driving unit, and the through hole communicated with the other end of the detection chamber by a fourth flow path; and
a gas outlet hole communicated with the through hole by a fifth flow path.

2. The press-based fluidic transportation and diagnosis device of claim 1, wherein the press-based fluidic transportation and diagnosis device sequentially comprises a first substrate, a second substrate, a third substrate and a bottom plate from the top plate.

3. The press-based fluidic transportation and diagnosis device of claim 2, wherein the top plate, the first substrate, the second substrate, the third substrate and the bottom plate are sequentially stacked so as to form the first reagent storage chamber, the second reagent storage chamber, the sample inflow chamber and the detection chamber.

4. The press-based fluidic transportation and diagnosis device of claim 2, wherein the top plate, the first substrate, the second substrate and the third substrate are sequentially stacked so as to form the through hole and the gas outlet hole.

5. The press-based fluidic transportation and diagnosis device of claim 2, further comprising a first plastic sheet and a plurality of second plastic sheets, wherein the first plastic sheet is disposed between the top plate and the first substrate, and the second plastic sheets are disposed between the first substrate and the second substrate.

6. The press-based fluidic transportation and diagnosis device of claim 2, wherein the first flow path is disposed on the second substrate, the second flow path, the third flow path and the fifth flow path are disposed on the third substrate.

7. The press-based fluidic transportation and diagnosis device of claim 5, wherein the fourth flow path is disposed on one of the second plastic sheets.

8. The press-based fluidic transportation and diagnosis device of claim 2, wherein a thickness of the first substrate, the second substrate and the third substrate is 1.5 mm, respectively, and the first substrate, the second substrate and the third substrate are all made of polymethacrylate.

9. The press-based fluidic transportation and diagnosis device of claim 1, wherein a volume of the first reagent storage chamber is smaller than a volume of the second reagent storage chamber.

10. The press-based fluidic transportation and diagnosis device of claim 1, wherein a material of the press-based driving unit is nitrile butadiene rubber.

11. The press-based fluidic transportation and diagnosis device of claim 1, wherein the first flow path is a curved type and has a width of 0.4 mm.

12. A detection method of solution colorimetric analysis, comprising:
providing the press-based fluidic transportation and diagnosis device of claim 1;
performing a reagent filling step, wherein the first reagent is filled into the first reagent storage chamber from the first reagent inflow hole, the second reagent is filled into the second reagent storage chamber from the second reagent inflow hole, and a detachable sealing film is used to seal the first reagent inflow hole and a tape is used to seal the second reagent inflow hole;
performing a sample inflowing step, wherein a sample is injected into the sample inflow hole, and the press-based driving unit is pressed simultaneously, so that an air in the press-based fluidic transportation and diagnosis device is discharged from the gas outlet hole;
performing a sample separating step, wherein the gas outlet hole is blocked and the press-based driving unit is released, so that the sample is separated and purified by the separation membrane to obtain a tested substance;
performing a degassing step, wherein the detachable sealing film is torn off and sealing the sample inflow hole, and the press-based driving unit is pressed repeatedly, so that the air in the press-based fluidic transportation and diagnosis device is discharged from the gas outlet hole;
performing a mixing step, wherein the gas outlet hole is blocked and the press-based driving unit is released, so that the first reagent and the second reagent are flowed into the sample inflow chamber and reacted with the tested substance to form a detected solution, and the detected solution is flowed into the detection chamber by the third flow path; and
performing a detecting step, wherein a result of the detected solution is analyzed by a colorimetry.

13. The detection method of solution colorimetric analysis of claim 12, wherein an area of the separation membrane is 1 cm² to 3 cm².

14. The detection method of solution colorimetric analysis of claim 12, wherein a volume of the sample is 20 μL to 100 μL.

15. The detection method of solution colorimetric analysis of claim 12, wherein the first reagent and the second reagent are mixed with each other to react with the tested substance.
